(19) United States
(12) Patent Application Publication
(10) Pub. No.: US 2010/0062271 A1
(43) Pub. Date: Mar. 11, 2010

(54) PROCESS FOR PRODUCING IMPROVED BINDERS FOR PLASTISOLS

(75) Inventors: Jan Hendrik Schattka, Hanau (DE); Gerd Loehden, Essen (DE); Winfried Belzner, Gruendau (DE); Ulrike Behrens, Hanau (DE); Christian Golditz, Bad Soden (DE); Sebastian Grimm, Moembris (DE); Herbert Jung, Karlstein (DE); Florian Matthes, Moembris (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/441,664

(22) PCT Filed: Aug. 15, 2007
(86) PCT No.: PCT/EP07/58423

§ 371 Date: Mar. 17, 2009

(30) Foreign Application Priority Data
Nov. 22, 2006 (DE) 102006055429.9
Dec. 1, 2006 (DE) 102006057145.2

(51) Int. Cl. C09D 133/10; C09D 133/24; B32B 15/09

(52) U.S. Cl. 428/458; 524/556; 524/555

(57) ABSTRACT

The invention relates to a process for preparing binders for plastisols that ensures high and consistent product quality over a multiplicity of batches. The binders obtained from this process allow the formulation of plastisols which possess improved stability on storage and, after gelling, improved mechanical properties.

The invention relates to an improved process for preparing copolymers that are used as binders in plastisol formulations.

By plastisols are meant, generally speaking, dispersions of finely divided polymer powders in plasticizers, which undergo gelling, i.e. curing, when heated to relatively high temperatures.
Plastisol:

by “plastisols” herein are meant mixtures which are composed of at least one binder and plasticizer. Plastisols may additionally comprise, for example, further binders, further plasticizers, fillers, rheological assistants, stabilizers, adhesion promoters, pigments and/or blowing agents.
Primary particles:

by “primary particles” herein are meant the particles present following emulsion polymerization in the resultant dispersion (latex).
Secondary particles:

by “secondary particles” herein are meant the particles obtained by drying the dispersions (latices) resulting from the emulsion polymerization.
(Meth)acrylates:

this notation refers herein both to the esters of methacrylic acid (such as methyl methacrylate, n-butyl methacrylate and cyclo-hexyl methacrylate, for example) and to the esters of acrylic acid.
Particle size

reference herein to a particle size, an average particle size or an average size of the particles, unless expressly stated otherwise, is to the volume-weighted average of the particle size distribution as obtainable, for example, by means of laser diffraction (with the aid, for instance, of a Coulter LS 13 320, manufactured by Beckman-Coulter).

Such plastisols, which occasionally are also referred to as “organosols”, find application for a very wide variety of purposes, more particularly as a sealing and sound insulation compound, as underbody protection for motor vehicles, as anti-corrosion coatings for metals, as a coating on sheet metal strips (coil coating) , for impregnating and coating substrates made from textile materials and paper (including, for example, coatings on the back of carpets), as floor coatings, as finishing coat compounds for floor coatings, for synthetic leather, as cable insulations, and many more.

One important field of application of plastisols is in the protection of metal bodywork panels on the underbody of motor vehicles against stone chipping.

This application imposes particularly exacting requirements on the plastisol pastes and on the gelled films.

An essential prerequisite, of course, is a high level of mechanical resistance to the abrasion occasioned by stone chipping. Moreover, an equally indispensable factor in the automotive industry is a maximum useful life of the plastisol pastes (storage stability).

The plastisol pastes must not have a propensity to absorb water, since water absorbed prior to gelling evaporates and leads to unwanted blistering at the high temperatures during the gelling operation.

Furthermore, the plastisol films are required to exhibit effective adhesion to the substrate (usually cathodically electrocoated sheet metal), which not only is an important prerequisite for the abrasion properties but also, furthermore, is vital for the anti-corrosion protection.

By far the most frequently used polymer, in volume terms, for the preparation of plastisols is polyvinyl chloride (PVC).

PVC-based plastisols display good properties and, moreover, are relatively inexpensive, this being one of the main reasons for their continued widespread use.

In the course of the preparation and use of PVC plastisols, however, a range of problems occur. The very preparation of PVC itself is not without its problems, since the workers at the production sites are exposed to a health hazard from the monomeric vinyl chloride. Residues of monomeric vinyl chloride in the PVC, moreover, might also be hazardous to health in the course of further processing or for the end users, although the levels are generally only in the ppb range.

A particularly serious factor associated with the application of PVC plastisols is that the PVC is both heat-sensitive and light-sensitive and has a propensity to give off hydrogen chloride. This is a grave problem in particular when the plastisol must be heated to a relatively high temperature, since the hydrogen chloride liberated under these conditions has a corrosive action and attacks metallic substrates. This is particularly significant when, in order to shorten the gelling time, comparatively high baking temperatures are employed, or when, as in the case of spot welding, temperatures occur which are locally high.

The greatest problem arises when wastes comprising PVC are disposed of: besides hydrogen chloride, it is possible under some circumstances for dioxins to be formed, which are highly toxic. In conjunction with steel scrap, PVC residues can lead to an increase in the chloride content of the molten steel, which is likewise deleterious.

For the reasons stated, research and ongoing development have been taking place for quite some time into alternatives to PVC plastisols which possess their good processing properties and end-use properties, but without the problems associated with the chlorine they contain.

Such proposals have included, for example, the replacement of vinyl chloride polymers, at least in part, by acrylic polymers (JP 60 258241, JP 61 185518, JP 61 207418). This approach, however, has only lessened, rather than solved, the problems occasioned by the chlorine content.

A variety of polymers—typically, however, not those prepared exclusively by emulsion polymerization—have been investigated as chlorine-free binders; examples have included polystyrene copolymers (e.g. DE 4034725) and polyolefins (e.g. DE 10048055). With regard to their processing properties and/or the properties of the pastes or of the gelled films, however, such plastisols fail to meet the requirements imposed by users on the basis of their many years of experience of PVC plastisols.

A good alternative to PVC, however, are poly(meth)acrylates, which for many years already have been described for the preparation of plastisols (e.g. DE 2543542, DE 3139090, DE 2722752, DE 2454235).

In recent years, plastisols based on polyalkyl (meth)acrylates have been the subject of numerous patent applications containing improvements to the various properties required.

A number of patents refer to the possibility of improving the adhesion through the incorporation of particular monomers.

These monomers may be, for example, nitrogen-containing monomers, as described for example in DE 4030080. DE 413834 describes a plastisol system featuring improved adhesion to cataphoretic sheet metal, based on polyalkyl (meth)acrylates, the binder comprising an acid anhydride as well as monomers with an alkyl substituent of 2-12 carbon atoms.

The improvement in the adhesion afforded by such monomers is, generally speaking, not very great, and in order, nevertheless, to achieve a significant improvement in the adhesion it is necessary to use correspondingly high quantities of these monomers. This in turn has an effect on other properties of the plastisol, such as the storage stability or the absorbency for plasticizers, for instance.

An alteration to the monomer composition is often accompanied by the dilemma of having to accept a deterioration in one property for an improvement in another.

There have also been numerous attempts to achieve the adhesion not through the binder itself but instead through a variety of different adhesion promoters added during the formulation of the plastisol.

Foremost amongst such adhesion promoters are blocked isocyanates, which are usually used in conjunction with amine derivatives as curing agents (examples include EP 214495, DE 3442646 and DE 3913807).

The use of blocked isocyanates is now widespread and is without doubt making a considerable contribution to the adhesion of plastisol films. Nevertheless, even with these adhesion promoters, there remains a problem of inadequate adhesion. Furthermore, these additives are decidedly expensive, and are therefore preferably used sparingly.

There are also a number of other proposed solutions, among which mention may also be made here of the use of saccharides as adhesion promoters (DE 10130888).

In spite of all of the efforts and approaches to a solution, the attainment of adequate adhesion of plastisol films on different substrates is still a problem encountered in the development of plastisols for particular applications.

As already mentioned, another important property of plastisols is the storage stability.

It is known that the storage stability goes up as the size of the primary particles increases. Back in 1974, in an application in the name of Teroson GmbH (DE 2454235), it was mentioned that the storage stability is too low if the particle size is too small. That specification established and elucidated a correlation between the required particle size and the glass transition temperature of the particles.

Experts in the art are now very largely in agreement that emulsion polymerization is particularly appropriate for the preparation of plastisol binders.

The preparation of large particles by emulsion polymerization is certainly possible in principle. Very large particles, however, lead to problems which must be taken into account. Thus in the course of the preparation it is necessary to operate with great caution and precision in order to achieve—and achieve reproducibly—the desired particle size. This usually has the effect of prolonging the polymerization operation, which in industrial production has adverse economic consequences.

Slight changes, of a kind not always preventable at acceptable expense and effort, such as fluctuations in the metering rate, for instance, may lead, in spite of correspondingly careful operation, to fluctuations in the particle size, and hence to fluctuations in the product quality.

Particularly in view of the widespread preparation of plastisol binders by emulsion polymerization in accordance with the batch or semibatch process, the significance attached to this problem is great: given the fact that, in a production campaign, many batches of a product are run, the probability that one or more of these batches will not have the required quality goes up considerably.

### Problem and Solution

The problem to be addressed was that of developing a process that, in connection with the preparation of binders for plastisols, allows high and consistent product quality to be ensured over a multiplicity of batches. The binders obtainable from this process ought to allow the formulation of plastisols which shall possess improved storage stability and, in the gelled state—improved mechanical properties: adhesion, tensile strength and/or breaking elongation.

A solution to this problem and to further problems which, while not explicitly cited, are nevertheless determinable or derivable readily from the circumstances discussed in the introduction, by a process having all of the features of Claim 1. Advantageous modifications to the process of the invention are protected in Claims 2 to 7, which are dependent on Claim 1.

With regard to the binder obtainable from the process of the invention, Claims 8 to 13 describe a solution to the relevant problem. Plastisols prepared from the binders—themselves prepared by the process of the invention—are protected in Claims 14 to 18, preferred conditions for their preparation in Claim 19, and their use in Claims 27-32.

Claims 20 to 26 claim gelled plastisol films which allow the problem on which the invention is based to be solved.

A surface coated with a plastisol formulated on the basis of a binder prepared in accordance with the invention is protected in Claim 33.

A key element of the process which allows the problem to be solved is an approach which uses a small amount of a dispersion A as the basis for all dispersions B. Consequently all of the binders prepared within a very long time period are based on a uniform standard.

It has been found, surprisingly, that the binders prepared by the process of the invention allow the formulation of plastisols superior to those formulated from conventionally prepared binders. This is true in terms both of properties prior to gelling (namely the storage stability) and of properties of the gelled plastisol film (in particular the mechanical properties).

### Solution

The first step of the process of the invention is the preparation of a polymer dispersion A. The preparation of this dispersion is in principle not subject to any restrictions; suitable for the preparation are the typical processes—those known to the skilled person—for preparing primary dispersions (e.g. emulsion polymerization, miniemulsion polymerization and micro-emulsion polymerization) and secondary dispersions (where pre-prepared polymers are dispersed in a second process step). Preference is given to emulsion polymerization.

In accordance with the invention the polymer dispersion A is intended to form the basis for a very large number of binder production batches prepared using it. The weight fraction of this polymer in the completed binder ought therefore to be very small. This is achieved when the particles of the polymer dispersion A have an average particle size (volume average) of not more than 200 nm. Preference is given to average particle sizes of less than 150 nm, with particle sizes of less than 125 nm being particularly preferred. In one particularly advantageous embodiment of the invention the particles of the polymer dispersion A have an average size of 80 to 120 nm.

For the further performance of the process of the invention the dispersion A is then—typically, though not necessarily, together with addition of water—charged to a reactor. It may further be sensible or necessary to add additional additives or auxiliaries (such as emulsifiers, initiators, electrolytes or chelating agents, for example).

Metered into this reactor then is a monomer b₁ or a mixture of monomers b₁ (a single monomer can be regarded in this case as a special case of a monomer mixture having only one component). This monomer or monomer mixture can be metered as it is or together with water, emulsifiers and/or other admixtures.

In typical embodiments of the invention
a homogeneous mixture of the monomer or monomer mixture with one or more emulsifiers or
a homogeneous mixture of the monomer or monomer mixture with an initiator and, where appropriate, a coinitiator, or an emulsion of the monomer or monomer mixture in water, where appropriate with addition of one or more emulsifiers, is metered.

The metering rate (i.e. the number of ml per minute metered into the reactor) can, via the metering time, be constant or else can be varied, in steps where appropriate. The metering rate at the beginning of metering is typically lower than at the end of metering.

Monomers used may include for example the following: methyl methacrylate, ethyl methacrylate, n-propyl methacrylate, isopropyl methacrylate, n-butyl methacrylate, isobutyl methacrylate, hydroxyethyl methacrylate, methyl acrylate, ethyl acrylate, n-propyl acrylate, isopropyl acrylate, n-butyl acrylate, isobutyl acrylate, 2-ethylhexyl acrylate, hydroxyethyl acrylate, methacrylic acid, acrylic acid, methacrylamide, acrylamide, styrene, butadiene, vinyl acetate, 1-vinylimidazole, ethylene glycol dimethacrylate, allyl methacrylate.

Monomers whose solubility in water is very poor have proved to be less advantageous for performing the invention. As a general rule it can be assumed that monomers having a solubility of less than 0.01% by weight at 20° C. in water are poorly suited. In certain cases, monomers of poor water solubility can be used as comonomers in small amounts (e.g. less than 5% by weight of the monomer mixture).

In one particular embodiment of the invention monomer mixture b₁ comprises the same monomers, in the same weight fractions, as are present in the polymers which form the particles of dispersion A.

Where the particles of dispersion A are composed of homopolymers, accordingly, and corresponding to this particular embodiment, the monomer b₁ is the same as is also present in the polymers of the particles of dispersion A.

It has emerged that the amount of monomer metered in this first step must in accordance with the invention be such that the average particle size of the particles following addition of the monomer or monomer mixture must be greater by at least 50 nm than that of the particles of dispersion A. The amount of monomers required for this purpose can be estimated with sufficient accuracy by means of geometric considerations, by relating the volume of the particles of dispersion A to the volume of the particles after the metering of the monomer b₁ or the monomer mixture b₁.

If the amount of monomer needed in order to attain the increase in particle size is greater than is to be expected in accordance with the volume growth, then new particles have formed, which corresponds to a less preferred embodiment of the invention. (Generally speaking, a reduction in the amount of emulsifier, a reduction in the metering rate and/or a reduction in the amount of initiator will be able to contribute to avoidance of this less preferred course.)

Where appropriate it is possible in a further step, or in two or more further steps, to add in each case further monomers b₂, b₃, b₄, . . . or monomer mixtures b₂, b₃, b₄, . . .

The selection of the monomers, the possible addition of water, emulsifier and/or other admixtures, the form of addition (e.g. as a homogeneous mixture or as an emulsion) and the metering rate are all subject to the comments made above in relation to the monomer b₁ or mixture of monomers b₁.

The monomers added in later steps—the further monomers b₂, b₃, b₄, . . . or monomer mixtures b₂, b₃, b₄, . . . are to be different from the monomer b₁ added in the first step or different from the mixture of monomers b₁ added in the first step.

In accordance with the invention, in each step, the average particle size of the particles in the dispersion is to increase by at least 50 nm.

In this way, after the final metering, the polymer dispersion B is obtained, which as its polymer particles comprises the primary particles of the plastisol binder to be prepared.

From the multiplicity of monomers amenable to the process described, the (meth)acrylates, and more particularly the methacrylates, have emerged as being particularly advantageous. In one preferred embodiment of the invention, therefore, each of the monomer mixtures used contains at least 50% by weight of one or more monomers which are selected from the group of (meth)acrylates having a radical composed of not more than 4 carbon atoms, such as, for example, methyl (meth)acrylate, ethyl (meth)acrylate, n-propyl (meth)acrylate, isopropyl (meth)acrylate, n-butyl (meth)acrylate or isobutyl (meth) acrylate.

In one particularly preferred embodiment each of the monomer mixtures used contains at least 70% or at least 90% by weight of one or more monomers selected from the group of meth(acrylates) having a radical composed of not more than 4 carbon atoms.

If each of the monomer mixtures used contains at least 95% by weight of one or more monomers selected from the group of (meth)acrylates having a radical composed of not more than 4 carbon atoms, then this corresponds to a further particularly preferred embodiment of the invention.

Through the use of different monomers and/or monomer mixtures for the construction of the particles it is possible to adapt plastisol properties (such as the gelling behaviour and the storage stability, for example) to the requirements of the application. Not only the composition of the individual monomer additions but also the overall monomer composition of the particles are significant for the properties of the plastisol and of the gelled plastisol film.

In one particular embodiment of the invention the binders contain at least 25% by weight of methyl methacrylate and at least 15% by weight of butyl (meth)acrylates, it being possible for the latter to be n-butyl (meth)acrylate, isobutyl (meth)acrylate, tert-butyl (meth)acrylate or a mixture of these monomers. In one particularly preferred embodiment the binders contain at least 50% by weight of methyl (meth)acrylate and at least 25% by weight of butyl (meth)acrylates.

It has emerged that such binders are especially suitable for the preparation of plastisols having good storage stability, in which the last of the added monomer mixtures includes at least one monomer selected from the group consisting of methacrylic acid, acrylic acid, amides of methacrylic acid and amides of acrylic acid.

In one typical embodiment of the invention, in the last monomer mixture added, between 0.2% and 15% by weight of the stated monomers are used. Preference is given to amounts of 0.4% to 10% by weight; amounts of 0.6% to 5% by weight are particularly preferred.

The binders obtainable from the process described are also part of this invention.

The primary particles of the binder are, in accordance with the invention, larger than the particles of the dispersion A. In one preferred embodiment, moreover, they are larger than 400 nm. Particularly preferred primary particle sizes are those of more than 500 nm or more than 600 nm. In one particularly advantageous embodiment of the invention the particles of the polymer dispersion B have an average size of more than 800 nm.

In order to obtain the binder by the preparation process of the invention, the dispersion B is converted by spray drying into a powder which subsequently, where appropriate, is ground.

In one typical embodiment of the invention spray drying is carried out using a spraying tower into which the dispersion B is sprayed in from the top in an atomized form. This atomization may take place, for example, through nozzles or through a rotating perforated disc. Hot gas is passed through the spraying tower, typically in a cocurrent flow from top to bottom. At the lower part of the tower it is possible to withdraw the dried powder.

There are various ways, known to the skilled person, of exerting influence over the properties of the powder obtained. As well as the choice of the atomizing technique (i.e. nozzle or atomizer disc, for example) mention may be made here, by way of example, of dispersion pressure, disc speed, nozzle or disc geometry, tower gas entry temperature and gas exit temperature.

One particular embodiment of the invention achieves atomization through a nozzle through which, simultaneously with the dispersion, a gas is sprayed under pressure into the tower; as it undergoes pressure release, the gas breaks up the liquid into droplets.

The particles of the resulting powder (secondary particles) consist of an agglomeration or aggregation of numerous primary particles, which is why the average size of the secondary particles is always greater than that of the primary particles.

If desired or necessary, the average size of the secondary particles can be reduced by grinding. Grinding may take place by any of the methods known to the skilled person; for example, with the aid of a drum mill or pinned disc mill.

It has emerged that binders particularly suitable for plastisol preparation are those in which the secondary particle size is at least 12 times as great as the size of the primary particles. The size of the secondary particles is preferably at least 20 times as great as the size of the primary particles. Of particular preference are secondary particles whose size is at least 30 times as great as the size of the primary particles.

Various properties of a plastisol are significantly affected by the molecular weight of the binder's polymer chains; these properties include the storage stability of the plastisol paste, and the foaming behaviour on gelling. The viscosity number is frequently employed as a suitable measure of the molecular weight.

One preferred embodiment of the invention, therefore, uses binders whose viscosity number (to DIN EN ISO 1628-1 with an initial mass of 0.125 g per 100 ml of chloroform) is greater than 150 ml/g and less than 800 ml/g. Particularly preferred binders are those having viscosity numbers of between 180 ml/g and 500 ml/g or between 220 ml/g and 400 ml/g.

A further particularly preferred embodiment of the invention is that in which the viscosity number of the binder (to DIN EN ISO 1628-1 with an initial mass of 0.125 g per 100 ml of chloroform) is greater than 240 ml/g and less than 320 ml/g.

Additionally claimed is a plastisol which is preparable from one of the described binders by addition of at least one plastizicer. Generally speaking, besides this binder and this plasticizer, plastisols comprise further components such as, for example, fillers, rheological assistants, stabilizers, adhesion promoters, pigments and/or blowing agents, and also, if desired, further binders and/or further plasticizers.

In one particular embodiment the plasticizer used or, in the event that two or more plasticizers are employed, at least one of the plasticizers used has a vapour pressure at 20° C. of not more than 20 Pa. Where two or more plasticizers are used, or a plasticizer mixture, the vapour pressure of the mixture in the composition employed, at 20° C., is preferably not greater than 20 Pa.

In further preferred embodiments of the invention the corresponding vapour pressures of the plasticizer, one of the plasticizers, or the plasticizer mixture is not greater than 15 Pa, preferably not greater than 12 Pa or—most preferably—not greater than 10 Pa.

One parameter critical to processing is the viscosity of a plastisol. Depending on the envisaged utility and selected application method (e.g. extrusion, dipping, airless spraying) there are certain maximum viscosities to be observed.

It is therefore a particular embodiment of this invention for the plastisol to have, one hour after its preparation, a maximum viscosity of 25 Pa·s (at 30° C.) Or preferably 20 Pa·s. Particularly preferred plastisols are those whose viscosity one hour after their preparation has a maximum value of 15 Pa·s (at 30° C.) or, more preferably, 12 Pa·s.

For the preparation of plastisols there are a multiplicity of possible plasticizers that can be used. Furthermore, it is also possible to use mixtures of these plasticizers. The plasticizers include, among others, the following:
Esters of phthalic acid, such as diundecyl phthalate, diisodecyl phthalate, diisononyl phthalate, dioctyl phthalate, diethylhexyl phthalate, di-C7-C11-n-alkyl phthalate, dibutyl phthalate, diisobutyl phthalate, dicyclohexyl phthalate, dimethyl phthalate, diethyl phthalate, benzyl octyl phthalate, butyl benzyl phthalate, dibenzyl phthalate and tricresyl phosphate, dihexyl dicapryl phthalate.
Hydroxycarboxylic esters, such as esters of citric acid (for example tributyl O-acetylcitrate, triethyl O-acetylcitrate), esters of tartaric acid or esters of lactic acid.
Aliphatic dicarboxylic esters, such as esters of adipic acid (for example dioctyl adipate, diisodecyl adipate), esters of sebacic acid (for example dibutyl sebacate, dioctyl sebacate, bis(2-ethylhexyl)sebacate) or esters of azelaic acid.
Esters of trimellitic acid, such as tris-(2-ethylhexyl) trimellitate.
Esters of benzoic acid, such as benzyl benzoate.
Esters of phosphoric acid, such as tricresyl phosphate, triphenyl phosphate, diphenyl cresyl phosphate, diphenyl octyl phosphate, tris(2-ethylhexyl) phosphate, tris(2-butoxyethyl) phosphate.
Alkylsulphonic esters of phenol or of cresol, dibenzyltoluene, diphenyl ether.

One particular embodiment of the invention is characterized in that more than 50% by weight of the components of the plastisol that are liquid at room temperature are esters of phthalic acid. With further preference more than 70% by weight and with particular preference more than 90% by weight of the components of the plastisol that are liquid at room temperature are esters of phthalic acid.

In order to ensure good storage stability of the plastisol paste and in order to minimize the viscosity of this paste following preparation, the temperature during the preparation of the plastisol ought to be as low as possible. On the other hand, the mixing of the plastisol components inevitably introduces energy into the system, which without cooling leads to an increase in temperature. Hence technical requirements will be weighed against one another in order to arrive at a temperature which is not to be exceeded in the course of the plastisol preparation procedure. A preferred embodiment of this invention is that wherein, during the preparation of the plastisol, a temperature of 60° C. is not exceeded. The temperature of the plastisol during its preparation remains preferably below 50° C. and more preferably below 40° C. In one particularly preferred embodiment of the invention the temperature throughout the preparation of the plastisol is not greater than 35° C.

Additionally claimed are the films obtainable by gelling the aforementioned plastisols.

The gelling, sometimes also described as ‘thermal curing’, commonly takes place in a heating oven (a forced-air oven, for example) with typical residence times—dependent on the temperature—in the range from 10 to 30 minutes. Temperatures between 100° C. and 200° C. are often employed, preferably between 120° C. and 160° C.

For numerous applications the mechanical properties of such a plastisol film are of particular importance, and this is also reflected in the problem addressed by this invention.

If the tensile strength of such a plastisol film, measured in accordance with or in correspondence with

DIN EN ISO 527-1, is not lower than 1 MPa, then this corresponds to one particular embodiment of this invention. Further preferred are films whose tensile strength is at least 1.2 MPa or 1.5 MPa. Particularly preferred films are those having a tensile strength of at least 1.8 MPa or 2.2 MPa.

A further important mechanical property of the plastisol film is the breaking elongation, which according to one particular embodiment of the invention—likewise measured in accordance with or in correspondence with DIN EN ISO 527-1—ought to be at least 180%. The breaking elongation of the film is preferably not lower than 220% or 260%. Films having a breaking elongation of at least 300% are particularly preferred.

Generally speaking, the plastisol film is required to adhere effectively to the substrate to which it is to be applied. In automotive engineering this substrate is frequently a cataphoretically coated steel panel (the production of such materials has been known for a long time and has been described in many instances—cf. for instance DE 2751498, DE 2753861, DE 2732736, DE 2733188, DE 2833786), although other substrates as well are possible, such as untreated sheet steel, aluminium or plastics.

One appropriate way of assessing the adhesion of a plastisol film on the substrate in question is by the wedge film removal method. For this purpose the plastisol paste (in the formulation to be used) is applied in a wedge form, using a slotted doctor blade, to a surface corresponding to the utility, application taking place in such a way as to give a film thickness from 0 to 3 mm. The gelled plastisol film (wedge) is incised parallel to the film-thickness gradient, using a sharp blade, at 1 cm intervals, down to the substrate. The resulting plastisol strips 1 cm wide are removed from the substrate, beginning at the thin end.

The measure taken for the adhesion is the thickness of the film at the point of film tearing, with a low film thickness corresponding to effective adhesion. The film thickness at the tear point is determined using a film thickness gauge.

In one particular embodiment of the invention the plastisol film has an adhesion to untreated, cleaned steel sheet of more than 30 μm by the wedge film removal method. Preferably the adhesion is more than 50 μm or more than 75 μm. Particular preference is given to adhesions of more than 100 μm.

Also claimed is the use of the said plastisols for the coating of surfaces.

The surfaces may be of various kinds, may be of different materials, and may where appropriate have been treated; examples include surfaces of plastics, wood, chip and wood fibre materials, ceramic, cardboard and/or metals.

In one particular embodiment of the invention the surface to be coated is that of a metal panel. In a further preferred embodiment it is a metal panel surface coated with an electrophoretic deposition coating material; among such substrates are, for example, the cathodically electrocoated metal panels that are widespread in the automotive industry.

A corresponding coated metallic surface is likewise claimed. In this case the surface to be coated may be, for example, an untreated metal panel, oiled where appropriate, a cleaned metal panel, or a metal panel coated with cathodic electrocoat material.

The plastisols prepared in accordance with the invention are particularly suitable for use as underbody protection and for seam sealing, especially in the construction of cars and goods wagons.

Furthermore, they can be used with advantage wherever the intention is to damp the vibration of a surface.

Examples of such applications within private households include, for example, the casing of household appliances, such as washing machines, refrigerators, kitchen equipment and air-conditioning units. Another is the casing of personal computers.

Examples in building and construction materials are pipes, floors and wall panelling.

Particular preference is given to the coating of bodywork parts in the construction of cars. Where the coatings are used outside in the underbody and wheel-arch areas of a motor vehicle, then, in addition to the damping of the metal-panel vibrations, there are also reductions in the impact noises of stones, sand and water.

### Methods

### Viscosity Number

The viscosity number or reduced viscosity [η] of a solution can be taken as a measure of the average molecular weight.

From this it is possible to gain a coarse estimate of the molecular weight by the Mark-Houwink equation, with the aid of the Mark-Houwink constants a=0.83 and Kᵥ=0.0034 ml/g (for polymethyl methacrylate homopolymers at 25° C. in chloroform; taken from “Polymer Handbook: Fourth Edition”, J. Brandrup, E. H. Immergut, E. A. Grulke):

[η]=Kᵥ·M^{a}; Mark-Houwink equation

Accordingly, for average molecular weights of about 400 000 g/mol, the anticipated viscosity number is about 150 ml/g; for average molecular weights of about 1 000 000 g/mol the anticipated viscosity number is about 325 ml/g.

Unless expressly noted otherwise, the viscosity number figures specified in this text were determined in accordance with DIN EN ISO 1628-1 with an initial mass of 0.125 g per 100 ml of chloroform.

### Particle Size

For the measurement of the particle size the skilled person is aware of a series of methods.

One widespread method, which is also practicable for the measurement of a large number of samples of the kind occurring, for instance, in the context of production control, is that of laser diffraction. An exhaustive description of this method is present in

DIN ISO 13320-1. For its implementation use may be made, for example, of a ‘Coulter LS 13 320’ from the manufacturer Beckman-Coulter.

### Vapour Pressure

The vapour pressure can be determined by the method described in DIN EN 13016-1 (edition: 2006-01).

### Tensile Strength/Breaking Elongation

The tensile properties can be determined by the method described in DIN EN ISO 527-1.

### Adhesion by the Wedge Film Removal Method

The plastisol paste (in the formulation to be used) is applied in a wedge form, using a slotted doctor blade, to a surface under investigation, application taking place in such a way as to give a film thickness from 0 to 3 mm.

The gelled plastisol film (wedge) is incised parallel to the film-thickness gradient, using a sharp blade, at 1 cm intervals, down to the substrate. The resulting plastisol strips 1 cm wide are removed from the substrate, beginning at the thin end.

The measure taken for the adhesion is the thickness of the film at the point of film tearing, with a low film thickness corresponding to effective adhesion.

The film thickness at the tear point is determined using a film thickness gauge.

### Solids Content

The solids content of the dispersions can be determined experimentally, by weighing out a defined amount of dispersion onto a flat aluminium tray. This tray is dried to constant weight in a vacuum drying cabinet at 50° C. The solids content is calculated as follows: {final weight of dried polymer} divided by {initial mass of dispersion}.

### PREPARATION EXAMPLES

### Comparative Example C1 (State of the Art)

A 500 ml reactor is fitted with a thermometer, a connection for inert gas (nitrogen), a stirrer, a dropping funnel and a reflux condenser.

This reactor is charged with 150 g of water and heated to 80° C. by means of a water bath.

Up until the end of preparation of the dispersion, the reactor is blanketed with a gentle stream of nitrogen. Throughout the reaction time the temperature is maintained, by means of heating and cooling, at 80° C. The contents of the reactor are stirred, using a stirrer, at 200 revolutions per minute.

50 mg of potassium peroxodisulphate (initiator) are added to the reactor. Immediately thereafter a mixture of 0.08 g of diisooctyl sulphosuccinate (emulsifier) with 17.32 g of methyl methacrylate and 22.68 g of isobutyl methacrylate is metered in to the reactor at a rate of 20 g/hour. After the end of the metered feed the batch is stirred for an hour until the intermediate reaction time has come to an end.

Subsequently a mixture of 0.06 g of diisooctyl sulphosuccinate (emulsifier) with 30.83 g of methyl methacrylate and 29.17 g of n-butyl methacrylate is metered in to the reactor at a rate of 20 g/hour. After the end of the metered feed the batch is again stirred for an hour until the subsequent reaction time has come to an end.

After cooling, the dispersion is filtered through a gauze (mesh size 250 μm).

In a drying tower (from Niro; atomizer type) with centrifugal atomizer the polymer dispersion is converted into a powder. The tower exit temperature is 80° C.; the rotational speed of the atomizer disc is 20 000 min⁻¹.

### Example E1 (inventive)

A 500 ml reactor is fitted with a thermometer, a connection for inert gas (nitrogen), a stirrer, a dropping funnel and a reflux condenser.

This reactor is charged with 100 g of deionized water and 1.00 g of diisooctyl sulphosuccinate (emulsifier) and heated to 80° C. by means of a water bath.

Up until the end of preparation of the dispersion, the reactor is blanketed with a gentle stream of nitrogen. The contents of the reactor are stirred, using a stirrer, at 200 revolutions per minute.

In a separate vessel (emulsion reservoir) 48.98 g of methyl methacrylate, 64.14 g of isobutyl methacrylate, 1.30 g of diisooctyl sulphosuccinate and 50 g of deionized water are weighed out. Stirring (10 minutes at 200 revolutions per minute) produces a homogeneous emulsion.

In an Erlenmeyer flask, 50 mg of potassium peroxodisulphate, and, in a further Erlenmeyer flask, 50 mg of sodium disulphite are dissolved, each in 1 ml of water.

30 g of the emulsion from the emulsion reservoir are transferred into the reactor. Then the polymerization is initiated by addition of the prepared sodium peroxodisulphate and sodium disulphite solutions.

When the temperature in the reactor has risen by 2° C., the remaining emulsion is metered into the reactor at a rate of 50 g/hour. If necessary, cooling with the water bath is used to prevent the temperature in the reactor rising above 86° C.

After the end of the metered feed, stirring is continued for an hour until the subsequent reaction time has come to an end.

After cooling, the dispersion (‘dispersion A’) is filtered through a gauze (mesh size 250 μm).

The solids content of this dispersion A (determined experimentally) is 44.0% by weight; the average particle size is 104 nm.

According to this example, dispersion A can be used in binder preparation as a raw material for about 500 dispersion batches B.

The procedure for the preparation of the dispersion B is then largely analogous to that of Comparative Example C1. The only difference is the addition to the reactor of 0.5 ml of dispersion A, after the initial water charge has reached the temperature of 80° C. and before the potassium peroxodisulphate initiator is added.

### DISCUSSION OF EXAMPLES

The primary particles not only of comparative Example C1 but also of dispersion B in the inventive Example I1 have internally a composition of 52:48 (mol %) methyl methacrylate to isobutyl methacrylate. The outer region of the particles as is obtained in the second monomer feed consists in both cases of methyl methacrylate and n-butyl methacrylate in a ratio of 60:40 (mol %). The particles of the dispersion A in the inventive Example I1 have the monomer composition 52:48 (mol %; methyl methacrylate to isobutyl methacrylate) (and therefore the same composition as the first feed in the case of the preparation of dispersion B in Example I1).

The dispersion in comparative Example C1 was prepared 6 times, with average particle sizes of between 673 nm and 861 nm being obtained. The average value from the experiments was 784 nm.

The multiply prepared dispersion B in inventive Example I1, using the same dispersion A, had a much lower spread of average particle sizes: with an average from all 6 experiments of 806 nm, the lowest measure of measured particle size was 792 nm; while the largest measured particle size was 817 nm.

Whereas in the case of comparative Example C1 the slow metering (particularly at the beginning of the first metered feed) is critical, it is possible in the case of the inventive Example I1 to meter at a higher rate from the start:

Thus a doubling in the metering rates has no effect in the case of Example I1, whereas in the case of comparative Example C1 the achievable particle size is much lower.

The particle size achieved also reacts with corresponding sensitivity to unintended fluctuations in the metering rate.

1. Process A process for preparing a binder for plastisols, characterized in that wherein
first of all a polymer dispersion A is prepared whose particles are not larger than 200 nm,
then a portion of dispersion A, together where appropriate with additional water and/or additives or auxiliaries, is charged to a reactor and
a monomer or a monomer mixture
where the monomer or each monomer has a water-solubility of in each case more than 0.01% by weight at 20° C.,
together where appropriate with water, emulsifier or other admixtures, is metered into this reactor and polymerized therein in such a way that the average size of the particles rises by at least 50 nm, and then
where appropriate, one or more further monomers or monomer mixtures,
which are different from the first monomer or first monomer mixture, and where, again, the monomer or each monomer has a water-solubility of in each case more than 0.01% by weight at 20° C.,
together where appropriate with water, emulsifier or other admixtures, are metered into this reactor and polymerized therein in such a way that the average size of the particles rises in each case by at least 50 nm, and
then the resulting dispersion B is spray-dried to give a powder which, as it is or, where appropriate, after complete or partial grinding, constitutes the binder.

2. The process for preparing a binder for plastisols according to claim 1, wherein the monomer composition of the particles in dispersion A is the same as that of the monomer mixture added first.

3. The process for preparing a binder for plastisols according to claim 1, wherein each of the monomer mixtures used contains at least 50% by weight of one or more monomers selected from the group consisting of (meth)acrylates having a radical of not more than 4 carbon atoms.

4. The process for preparing a binder for plastisols according to claim 1, wherein each of the monomer mixtures used contains at least 90% by weight of one or more monomers selected from the group consisting of (meth)acrylates having a radical of not more than 4 carbon atoms.

5. The process for preparing a binder for plastisols according to claim 1, wherein each of the monomer mixtures used contains at least 90% by weight of one or more monomers selected from the group consisting of methacrylates having a radical of not more than 4 carbon atoms.

6. The process for preparing a binder for plastisols according to claim 1, wherein the last of the monomer mixtures added comprises at least one monomer selected from the group consisting of methacrylic acid, acrylic acid, amides of methacrylic acid and amides of acrylic acid.

7. The process for preparing a binder for plastisols according to claim 1, wherein the last of the monomer mixtures added contains 0.2% to 15% by weight of monomers selected from the group consisting of methacrylic acid, acrylic acid, amides of methacrylic acid and amides of acrylic acid.

8. A binder preparable according to claim 1.

9. The binder according to claim 8, wherein
the primary particles have an average diameter of more than 400 nm and
the average diameter of the secondary particles is at least twelve times as great as the average diameter of the primary particles.

10. The binder according to claim 8, wherein
the primary particles have an average diameter of more than 600 nm and
the average diameter of the secondary particles is at least 20 times as great as the average diameter of the primary particles.

11. The binder according to claim 8, wherein the overall composition of the polymers contains not less than 25% by weight of methyl methacrylate and not less than 15% by weight of butyl methacrylate(s).

12. The binder according to claim 8, wherein the overall composition of the polymers contains not less than 50% by weight of methyl methacrylate and not less than 25% by weight of butyl methacrylate(s).

13. The binder according to claim 8, wherein the viscosity number to DIN EN ISO 1628-1 of a solution of 0.125 g of binder per 100 ml of chloroform is greater than 150 ml/g and less than 800 ml/g.

14. A plastisol preparable with a binder according to claim 8.

15. The plastisol according to claim 14, wherein
it comprises at least one plasticizer which has a vapour pressure at 20° C. of not more than 20 Pa and
60 minutes after preparation it has a viscosity of less than 25 Pa·s as measured at 30° C.

16. The plastisol according to claim 14, wherein
it comprises at least one plasticizer which has a vapour pressure at 20° C. of not more than 12 Pa and
60 minutes after preparation it has a viscosity of less than 15 Pa·s as measured at 30° C.

17. The plastisol according to Claim 14, wherein more than 50% by weight of the components of the plastisol that are liquid at room temperature are esters of phthalic acid.

18. The plastisol according to Claim 14, wherein more than 90% by weight of the components of the plastisol that are liquid at room temperature are esters of phthalic acid.

19. A preparation of a plastisol according to claim 14, wherein during the preparation the paste does not become hotter than 60° C.

20. A gelled plastisol film obtainable from a plastisol according to claim 14.

21. The gelled plastisol film according to claim 20, wherein the gelled film has a tensile strength of not less than 1 MPa.

22. The gelled plastisol film according to claim 20, wherein the gelled film has a tensile strength of not less than 1.8 MPa.

23. The gelled plastisol film according to claim 20, wherein the gelled film has a breaking elongation of not less than 180%.

24. The gelled plastisol film according to claim 20, wherein the gelled film has a breaking elongation of not less than 260%.

25. The gelled plastisol film according to claim 20, wherein the gelled film has an adhesion of more than 30 μm by the wedge film removal method.

26. The gelled plastisol film according to claim 20, wherein the gelled film has an adhesion of more than 75 μm by the wedge film removal method.

27. A surface coating comprising a plastisol according to claim 14.

28. A coating for metal sheets comprising a plastisol according to claim 14.

29. A coating for electrophoretically deposition-coated metal sheets comprising a plastisol according to claim 14.

30. An underbody protection comprising a plastisol according to claim 14.

31. A seam covering comprising a plastisol according to claim 14.

32. A coating for damping sheet-metal vibrations
comprising a plastisol according to claim 14.

33. A coated metallic surface, wherein the coating has taken place with a plastisol according to claim 14, where appropriate following a prior electrodeposition coating.
